(19) United States
(12) Patent Application Publication
(10) Pub. No.: US 2006/0203212 A1
(43) Pub. Date: Sep. 14, 2006

(54) Lamp apparatus

(76) Inventor: Michael Held, Taipei (TW)

Correspondence Address: RABIN & Berdo, PC, 1101 14TH STREET, NW, SUITE 500, WASHINGTON, DC, 20005, US

(21) Appl. No.: 11/365,827

(22) Filed: Mar. 2, 2006

(30) Foreign Application Priority Data
Mar. 10, 2005 (TW) 94107380

(51) Int. Cl. G03B 21/14

(52) U.S. Cl. 353/119

(57) ABSTRACT

A lamp apparatus including a projector and a controlling component is provided. The projector has a light source for projecting a beam of light. The controlling component is used for controlling the light source of the projector, so that the beam of light projected by the light source may be used as a projection light or an illumination light. When the controlling component controls the beam of light to be a projection light, the light is used for projecting an image. When the controlling component controls the beam of light to be an illumination light, the light is used for illumination.

This application claims the benefit of Taiwan application Serial No. 94107380, filed Mar. 10, 2005 the subject matter of which is incorporated herein by reference.

### BACKGROUND OF THE INVENTION

1. Field of the Invention

The invention relates in general to a lamp apparatus, and more particularly to a lamp apparatus having both projector and illumination functions.

2. Description of the Related Art

Projectors, which are gaining a wider and wider popularity nowadays, are used not only for business purpose such as in office or conference, but also in household as a device for screening photos, videos, or movies.

Lamps are more than an illumination appliance to modern people; lamps are crucial in creating a worm and cozy atmosphere. The variety and disposition of the lamps have much to do with the feeling of the user and the atmosphere in the environment. The user may dispose a desk lamp on the bedside cupboard so that the user may read or do other activities while lying on the bed. It is also quite popular that an interior designer would adopt a stand lamp to make the lounge warmer and harmonious.

When the user is watching a video or a film, the user has to dim the surrounding light so that the projector can screen an image on the screen, lest the image might be polluted by the surrounding light and become blurred. After the viewing is over, the original illumination is resumed.

It would be a great relief to modern people if the considerate design of technology can help them to release their stress. Particularly, it would be enjoyable to modern people when watching a favorite film with a large screen under a tender illumination at home.

### SUMMARY OF THE INVENTION

It is therefore the object of the invention to provide a lamp apparatus having both projector and illumination function, so that the lamp apparatus not only has illumination function but also can be used a projector.

According to the object of the invention, a lamp apparatus including a projector and a controlling component is provided. The projector has a light source for projecting a beam of light. The controlling component is used for controlling the light source of the projector, so that the beam of light projected by the light source may be used as a projection light or an illumination light. When the controlling component controls the beam of light to be a projection light, the light is used for projecting an image. When the controlling component controls the beam of light to be an illumination light, the light is used for illumination.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a 3-D diagram of a lamp apparatus according to a first embodiment of the invention;

FIG. 1B is a structural diagram of a projector;

FIG. 1C is a structural diagram of the projector with a rotated first reflector;

FIG. 1D is a diagram showing the beam of light projected from a camera lens of the projector;

FIG. 1E is a diagram showing the beam of light projected from a lateral side of the projector;

FIG. 2A is a side view of a lamp apparatus;

FIG. 2B is a diagram showing the rotation of the projector; and

FIG. 3 is a top view of a lamp apparatus according to a second embodiment of the invention.

### DETAILED DESCRIPTION OF THE INVENTION

A lamp apparatus including a projector and a controlling component is provided. The projector has a light source for projecting a beam of light. The light source may include a projecting component. The controlling component is for controlling the projecting component of the projector so that the beam of light projected by the projecting component may be used as a projection light or an illumination light. When the controlling component controls the beam of light to be a projection light, the light is used for projecting an image. When the controlling component controls the beam of light to be an illumination light, the light is used for illumination.

### First Embodiment

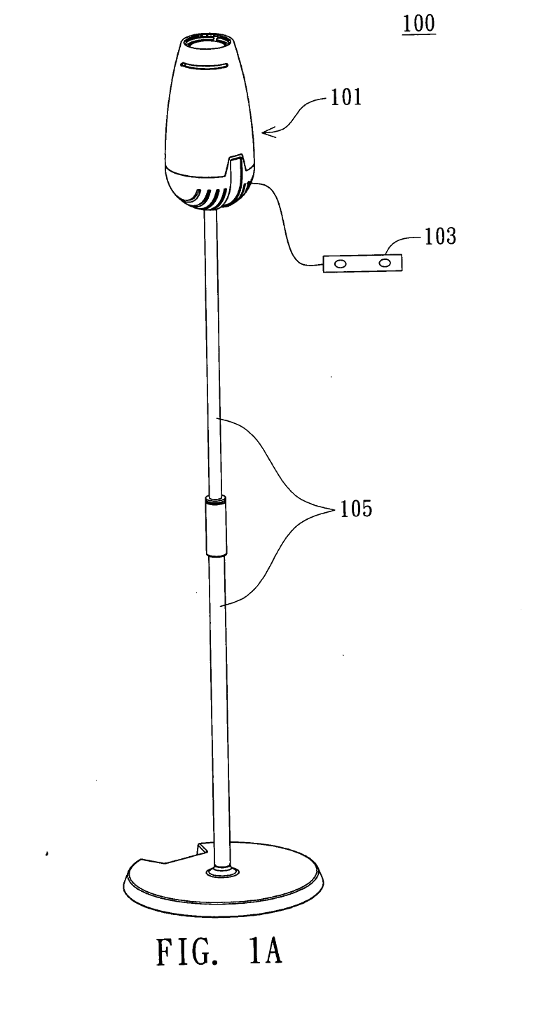

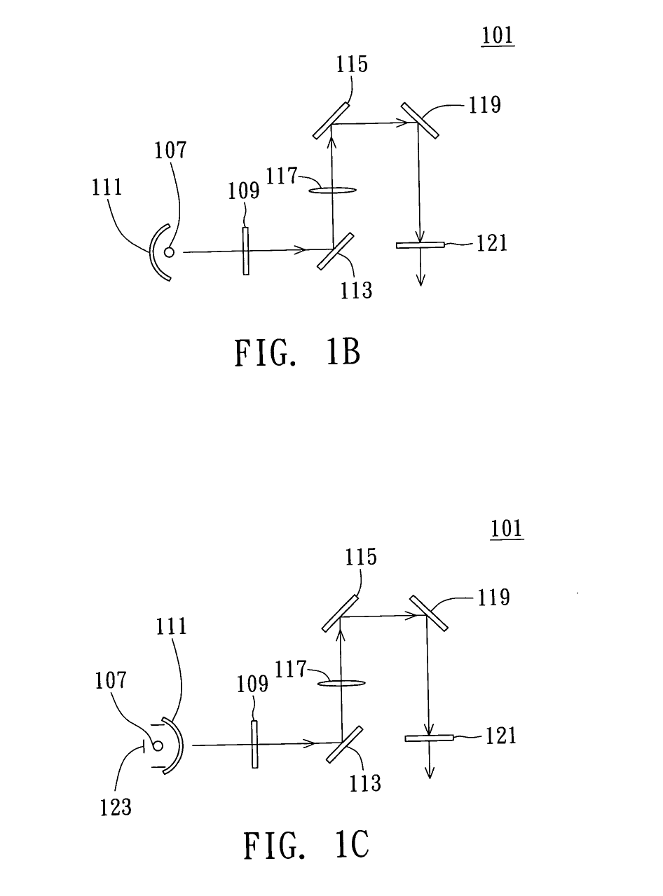

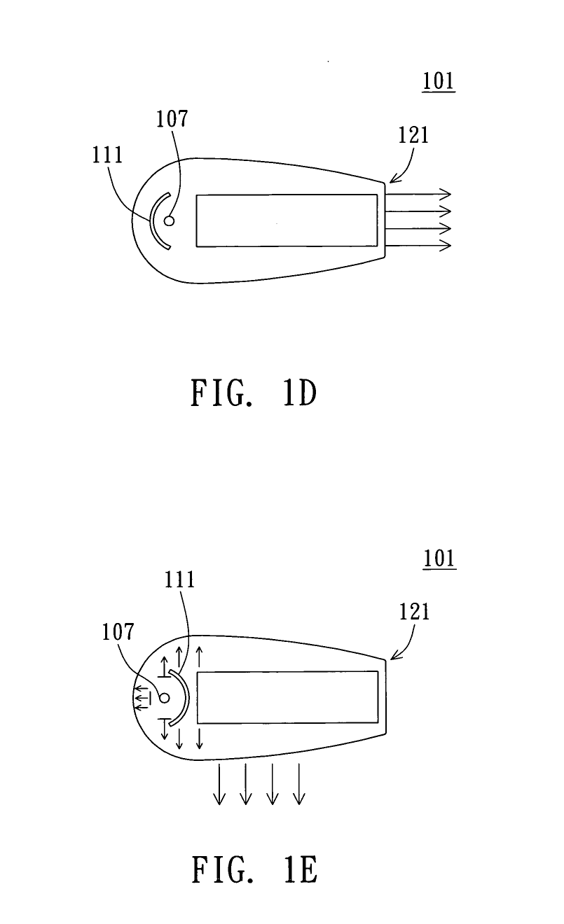

Referring to FIG. 1A, a 3-D diagram of a lamp apparatus according to a first embodiment of the invention is shown. Lamp apparatus 100 includes a projector 101, a controlling component 103 and an adjusting frame 105. Referring to FIG. 1B, a structural diagram of a projector is shown. The projector 101 may be a liquid crystal projector or a penetration projector. The projector 101 includes a projecting component 107, a color wheel 109, a first reflector 111, a second reflector 113, a third reflector 115, a lens 117, a digital micro-lens device (DMD) 119 and a camera lens 121. When used as projection light, the highly directional beam of light generated by the projecting component 107 is reflected by the first reflector 111 and then passes through the color wheel 109 to be split into the red, the green and the blue colors. The second reflector 113 to be focused by the lens 117 then guides the projection light. Next, the projection light is guided to the DMD by the third reflector 115 to adjust the brightness of the beam of light. At last, the projected light is enlarged and imaged on the screen by the camera lens 121. A controlling component 103, such as a cabled or a wireless controller for instance, controls and adjusts the direction of the first reflector 111 to switch the projection light as the illumination light. In the present embodiment, the first reflector 111, having light-focusing function, adjusts the optical path of the light emitted from the projector by controlling the position and direction of the first reflector 111.

Referring to both FIG. 1B and FIG. 1C. FIG. 1C is a structural diagram of the projector with a rotated first reflector. By changing the direction of the first reflector 111, the beam of light is emitted directly instead of being emitted to the camera lens 121 via the original optical path, and, when incorporated with a mixer 123 as shown in FIG. 1C, a foggy lens for instance, adjusts the highly directional beam of light emitted by to projecting component 107 to a weakly directional beam of light. The weakly directional beam of light is used as the illumination light.

Referring to FIG. 1D and FIG. 1E. FIG. 1D is a diagram showing the beam of light projected from a camera lens of the projector. FIG. 1E is a diagram showing the beam of light emitted by a projecting component 107 and projected from a lateral side of the projector. Switching the lamp apparatus 100 from illumination purpose to the projector 101 purpose can be achieved by changing the rotation direction of the first reflector 111, so that the beam of light emitted by the first projection light source 107 will be emitted through the lateral side of the projector as shown in FIG. 1E instead of being emitted through the camera lens 121. However, the optical path of the beam of light can also be changed by changing the rotation direction of other reflectors such as the second reflector or the third reflector for instance to prevent the beam of light from being emitted through the camera lens.

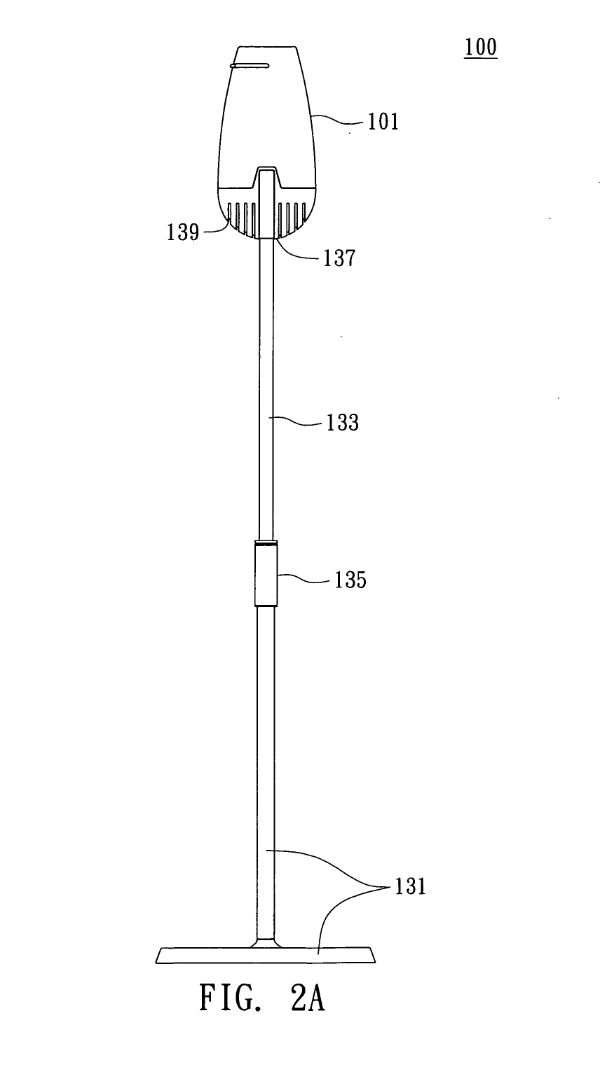

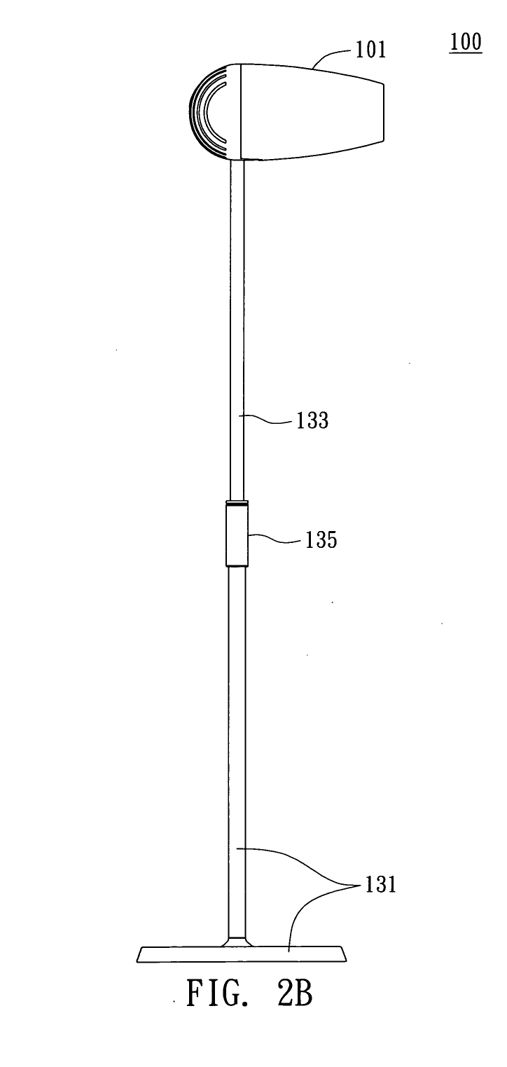

Referring to FIG. 2A, FIG. 2A is a side view of a lamp apparatus. Adjusting frame 105 has a base 131, a receiving portion 133 and an adjusting portion 135. The projector 101 has a pivotal portion 137 coupled to the receiving portion 133. The weight of the projector 101 is transmitted to the base 131 via the pivotal portion 137, the receiving portion 133 and the adjusting portion 135.

Referring to both FIG. 2A and FIG. 2B. FIG. 2B is a diagram showing the rotation of the projector. Via the pivotal portion 137 disposed at the bottom of the projector 101, the projector 101 may rotate along the pivotal portion 137. Meanwhile, the height of the adjusting portion 135 is adjustable to fit the height or preference of the user. The adjusting portion 135 may be a rotation type or a press type. One end of the receiving portion 133 is coupled to the pivotal portion 137 of the projector 101, while another end is inserted in the base 131 via the adjusting portion 135. On the other hand, several dissipation openings 139 are disposed at the bottom of the projector 101 but adjacent to the projecting component 107 to reduce the temperature of the projector 101 and prevent the electronic components disposed inside the projector 101 from being damaged due to the high temperature.

### Second Embodiment

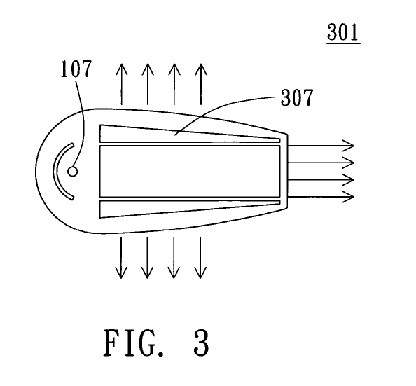

Referring to FIG. 3, a top view of a lamp apparatus according to a second embodiment of the invention is shown. The second embodiment differs with the first embodiment in that the light source includes the projecting component 107 and a luminous component 307. The projecting component 107 and the luminous component 307 may be of various luminous components. For example, the projecting component 107 may be selected from one of a light emitting diode, a halogen light, a metal halide, a UHP/UHE or a xenon arc, while the illumination component 307 may be an ordinary light source such a light emitting diode, an incandescent lamp, or a discharge lamp. The projecting component generates highly directional projection light, and the luminous component generates weakly directional illumination light. The controlling component determines whether to use the lamp apparatus for illumination purpose or projection purpose according to whether the luminous component 307 or the projecting component 107 is used to emit the light. When the controlling component controls the projecting component 107 to emit the beam of light, the luminous component 307 is switched off, and the projecting component 107 emits highly directional projection light for the projector to project an image. When the illumination component 307 is switched on and the projecting component 107 is switched off, the illumination component 307 emits weakly directional light, evenly distributed to be used for illumination. With the adjusting frame 105, the height of the projector 101 is adjustable to fit the height and preference of the user. Moreover, with the design of the pivotal portion 137, the beam of light or the projected images can be projected upwardly and the user may even screen a movie onto the ceiling.

A lamp apparatus having both projector and illumination functions is disclosed in above embodiments of the invention. In the first embodiment, the single light source may be switched between illumination function and projector function by changing the direction of a reflector. In the second embodiment, an extra luminous component is disposed so that two different luminous components are respectively used as a light source for illumination function and a light source for projector function. Furthermore, the adjusting frame may be used to adjust the height of the projector, so that the user may control the projection position of the projector according to the height and preference of the user, adding more fun to everyday life and higher added value to the product.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lamp apparatus, comprising
a projector having a light source; and
a controlling component for controlling the light source of the projector to emit a projection light or an illumination light,
wherein the projection light is for the projector to project an image, and the illumination light is for illuminating the environment of the lamp apparatus.

2. The lamp apparatus according to claim 1, wherein the light source is selected from one of a light emitting diode, a halogen light, a metal halide, a UHP/UHE and a xenon arc.

3. The lamp apparatus according to claim 1, wherein the projector further comprises a reflector for receiving the light emitted by the light source, and the controlling component controls the direction of the reflector to switch the light emitted by the light source to be the projection light or the illumination light.

4. The lamp apparatus according to claim 1, wherein the light source comprises a projecting component and an illumination component, the projecting component emits the projection light, the illumination component emits the illumination light, and the controlling component selectively actives the projecting component or the illumination component.

5. The lamp apparatus according to claim 4, wherein the projecting component is selected from one of the light emitting diode, the halogen light, the metal halide, the UHP/UHE and the xenon arc.

6. The lamp apparatus according to claim 4, wherein the illumination component is selected from one of the light emitting diode, an incandescent lamp, and a discharge lamp.

7. The lamp apparatus according to claim 1, wherein the lamp apparatus further comprises an adjusting frame, comprising
a base;
a receiving portion for receiving the projector; and
an adjusting portion having two ends respectively coupled to the base and the receiving portion, wherein the adjusting portion is for adjusting the height of the adjusting frame.

8. The lamp apparatus according to claim 7, wherein the adjusting frame further comprises a pivotal portion disposed between the receiving portion and the projector so that the projector is pivotally connected to the adjusting frame.

9. The lamp apparatus according to claim 1, wherein the projector comprises a plurality of dissipation openings disposed adjacent to the light source for dissipating heat.
